(19) United States
(12) Patent Application Publication
(10) Pub. No.: US 2002/0037347 A1
(43) Pub. Date: Mar. 28, 2002

(54) Method of preserving fresh food

(75) Inventor: Sanka Jiro, Nerima-ku (JP)

Correspondence Address: OLIFF & BERRIDGE, PLC, P.O. BOX 19928, ALEXANDRIA, VA, 22320, US

(73) Assignee: Jiro Sanka

(21) Appl. No.: 09/767,862

(22) Filed: Jan. 24, 2001

(30) Foreign Application Priority Data
Sep. 27, 2000 (JP) 2000-293909

(51) Int. Cl. A23L 1/00

(52) U.S. Cl. 426/419; 426/615

(57) ABSTRACT

For preserving fresh foods at low cost, using a packing material safe for global environment, while the freshness, color, taste and texture of the fresh foods are retained, a method of the present invention arranges broccoli in a corrugated carton box in which a freshness-keeping bag is spread, and sprays water on the broccoli at farms. The corrugated carton boxes are loaded on a pallet at a selection platform to be then placed in a preliminary vacuum chamber to preliminarily cool the broccoli in vacuum. The corrugated carton boxes on the pallet are placed in a cold insulation chamber and the opening of the freshness-keeping bag is closed. Cooling air blown from a cooler in an enforced manner is circulated through an air permeable hole of the corrugated carton box in the cold insulation chamber, to cool the broccoli in the corrugated carton box. The broccoli in the corrugated carton box is subsequently stored or transported while the broccoli is kept cool in a container, a warehouse or a cold insulation vehicle, for subsequent shipping.

### BACKGROUND OF THE INVENTION

1. Field of the Invention

The present invention relates to a method of preserving fresh foods, mainly fresh vegetables or fresh fruits.

2. Description of the Related Art

Fresh foods, for example broccoli, have conventionally been preserved and transported in the following manner. First, broccoli pieces separately harvested in individual farms are transported to selection platforms and are then packed in boxes. For the import of broccoli from foreign countries, for example, marine transport of broccoli requires ten plus several days, thus broccoli is placed together with ice in a wax-coated corrugated carton box. In this state, broccoli is imported in Japan. At ports in Japan, broccoli is placed in a styrene foam box as the broccoli is still in the corrugated carton box; and then, crush ice is also placed in the styrene foam box.

The broccoli in the styrene foam box is then delivered to central markets or supermarket centers. However, broccoli cropped in domestic farms have been transported, using styrene foam box and crush ice, without using wax-coated corrugated carton box.

The aforementioned conventional methods have the following problems to be overcome.

First of all, a wax-coated corrugated carton box used for the delivery is grouped as garbage to be classified, unlike general corrugated carton boxes, and styrene foam causes pollution such as dioxin pollution during incineration.

A second problem is that the size of each styrene foam box containing fresh foods packed together with ice is unavoidably so large and heavy that a person who lacks physical strength cannot carry the box. A large and heavy delivery box of fresh foods costs high delivery expense for mass-scale delivery. Furthermore, the cost of ice and the cost of packing the ice are so high that these costs are added to the cost of broccoli.

### SUMMARY OF THE INVENTION

It is an objective of the present invention to provide a method of preserving fresh foods, using a packing material environmentally safe but never causing the deterioration of the freshness, color, taste and texture of the fresh foods.

It is another objective of the present invention to provide a method of preserving fresh foods, which is capable of reducing the size and weight of one box of fresh foods with no deterioration of the freshness of fresh foods, thereby improving the handleability and also capable of reducing the running cost for transport.

The method of preserving fresh foods in one aspect of the present invention comprises:

a first step of depositing water on the fresh foods;

a second step of vacuum cooling the fresh foods in a vacuum cooling chamber; and

a third step of further cooling the vacuum cooled fresh foods by cooling air in a cooling chamber.

In this aspect of the present invention, fresh foods can be cooled to a desired storing temperature in a relatively short time through the two-step cooling of the second and third steps. By vacuum cooling at the second step, fresh foods can be cooled to a temperature close to the storing temperature in a short time. Herein, fresh foods are cooled under vacuum cooling, because of the deprivation of vaporization heat during the evaporation of moisture contained in fresh foods. Owing to the first step of preliminarily depositing water on fresh foods, fresh foods can be cooled utilizing vaporization heat during the evaporation of the water. In other words, the ratio of the vaporizing moisture in fresh foods can be reduced, which serves to prevent fresh foods from falling into a dehydrated state. Additionally, fresh foods fall into dehydrated conditions, when fresh foods are cooled to the storing temperature at the second step (vacuum cooling) alone. Cooling of fresh foods at a combination of the second and third steps can prevent fresh foods from falling into dehydrated conditions.

The first step may comprise:

a step of packing the fresh foods in at least one transport box; and

a step of spraying water on the fresh foods packed in the transport box.

Then, a freshness-keeping bag, in which the fresh foods are put, may be spread in the transport box. The freshness-keeping bag may be made of a material capable of reducing an oxygen volume per unit volume in the freshness-keeping bag, compared with the oxygen volume in atmosphere, and capable of raising a carbon dioxide volume per unit volume in the freshness-keeping bag, compared with the carbon dioxide volume in atmosphere. Via the gas adjustment in the freshness-keeping bag in such manner, the period in which the freshness of the fresh foods is kept can be prolonged.

The fresh foods may be placed in plural layers in the transport box in which the freshness-keeping bag is spread. Then, in the first step, water may be sprayed on the fresh foods in an upper top layer every time a layer of the fresh foods is packed in the box. Thus, sufficient water can be sprayed on each layer of the fresh foods.

An opening of the freshness-keeping bag may be closed after the second step. In such manner, vaporizing steam in the freshness-keeping bag can readily be discharged outside from the opening of the freshness-keeping bag throughout the second step. Thus, vaporization can be promoted.

Preferably, at least one air permeable hole is formed through each of six faces of the transport box which is a rectangular parallelepiped so that the cooling air used in the third step is circulated through the air permeable hole, to efficiently cool fresh foods.

A plurality of transport boxes may be placed in the cooling chamber in the third step and inner spaces of two of the transport boxes adjacently positioned may be in communication each other through the air permeable hole of each of the transport boxes. In such manner, fresh foods in all the transport boxes can be cooled uniformly while cooling air is introduced over fresh foods in all the transport boxes.

In the third step, the fresh foods may be cooled to a temperature of −1 to 3° C. Because the freshness of fresh foods can be preserved, with no occurrence of freezing phenomenon within the temperature range, for a relatively long period.

In this case, in the second step, the fresh foods may be vacuum cooled to a temperature of 2 to 6° C. Within the temperature range, no dehydration conditions emerge in the fresh foods during cooling in vacuum, and the cooling period at the subsequent third step can be set to a relatively short time.

The fresh foods may be fresh vegetables or fresh fruits. In this case, the method may comprise a step of harvesting the fresh vegetables or the fresh fruits at a temperature of 20° C. or less prior to the first step. Through the specification of the harvest timing in the form of a manual, the temperature control of the fresh foods can readily be done, leading to the stabilization of the quality of the fresh foods.

The present invention may further comprise a step of placing the transport box, in which the fresh foods cooled in the third step, in a cold insulation container and then transporting the cold insulation container. During transport, the fresh foods are cooled, so the freshness thereof can be retained.

The present invention may further comprise: a step of storing the fresh foods in the cold insulation container in a warehouse kept cool; and a step of delivering the fresh foods in a cold insulation vehicle. The fresh foods kept cool and stored in the warehouse in such manner can be shipped in timing, coping with the shipping order. The storage period of the fresh foods in a warehouse can be controlled for the control of the shipping of the fresh foods.

The method of preserving fresh foods in another aspect of the present invention comprises a step of preserving the fresh foods transported via the first to third steps from foreign countries in a warehouse kept cool and a subsequent step of delivering the fresh foods in a cold insulation vehicle.

The first to third steps eliminate the need of the import of fresh foods from foreign countries, using ice and wax-coated corrugated carton box as has been done conventionally. Even domestically, furthermore, fresh foods can be kept cool and transported with no use of styrene foam box or crush ice.

Preferably, the insides of the cold insulation container, the warehouse or the cold insulation vehicle are individually cooled and kept at a temperature of −1 to +1° C., because fresh foods can be retained at optimum temperature in that case.

### BRIEF DESCRIPTION OF THE DRAWINGS

FIG. 1 is a flowchart explaining a method of preserving broccoli in accordance with the present invention, in which steps of the method at farms are shown;

FIG. 2 is a flowchart explaining the steps from a selection platform to marine transport following the steps in FIG. 1, in the method of preserving broccoli in accordance with an embodiment of the present invention;

FIG. 3 is a flowchart explaining the steps after unloading, subsequent to the steps in FIG. 2 in the method of preserving broccoli in accordance with the embodiment the present invention;

FIG. 4 is a schematic explanatory view of the state that two rows of broccoli pieces are put in a corrugated carton box with a freshness-keeping bag spread therein;

FIG. 5 is a schematic explanatory view depicting a step of preliminary vacuum cooling;

FIG. 6 is a schematic explanatory view depicting a step of closing the opening of the freshness-keeping bag after the step of preliminary vacuum cooling; and

FIG. 7 is a schematic explanatory view depicting a cooling step by cooling air.

### DESCRIPTION OF PREFERRED EMBODIMENTS

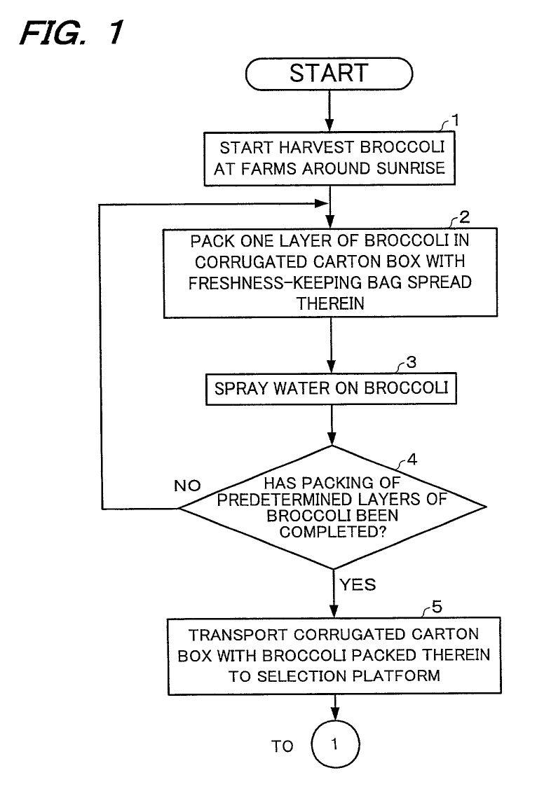

The embodiments of the present invention will now be described with reference to drawings. FIGS. 1 to 3 are flowcharts explaining the method of preserving imported broccoli according to the embodiments.

First Embodiment

Process at Farms

FIG. 1 shows a process at farms. In FIG. 1, broccoli is harvested in individual farms in export countries, for example USA (Step 1). In order to harvest broccoli in the individual farms at ambient temperature of 20° C. or less, preferably, it should be specified in a manual that broccoli be cropped within a time zone to complete the cropping work in the forenoon; for example, the cropping work starts around early morning at a low outdoor temperature, namely around sunrise. The reason lies in that all broccoli pieces can be retained at an almost fixed cold temperature in a subsequent cooling step, so as to stabilize the quality of broccoli.

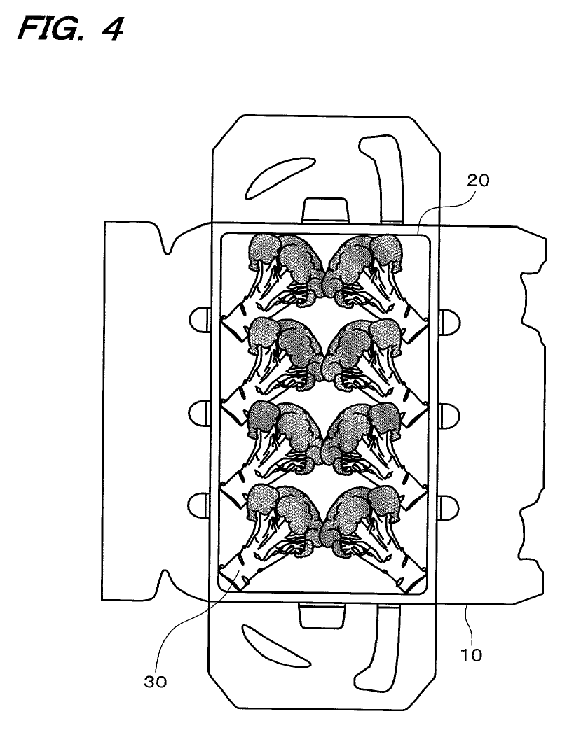

Individual farms then spread freshness-keeping bag 20 in corrugated carton box 10 with great air permeability, where for example two rows of broccoli 30 are placed, as shown in FIG. 4, (step 2). Unlike conventional art, the inside of the corrugated carton box 10 is not coated with wax. Additionally, “Xtend” under trade name as manufactured by StePac L. A., Ltd. can be used as the freshness-keeping box 20. However, the box is not limited to this merchandise. Herein, the details of the corrugated carton box 10 and the freshness-keeping bag 20 are described below.

As shown in FIG. 4, then, water is sprayed on the broccoli 30 to deposit water on the surface of the broccoli 3, while the freshness-keeping bag 20 is opened (step 3). The procedures at the steps 2 and 3 are repeated, until predetermined layers of broccoli pieces, for example 4 layers of broccoli pieces in total of 38 broccoli pieces, can be placed therein at step 4. The step 3 can be carried out in a repeated fashion in such a manner that water is sprayed on two rows of the broccoli 30 on the top layer immediately after the piling up of each layer.

The aforementioned steps 1 to 3 are carried out in individual farms. Thereafter, the broccoli 30 packed in the boxes is transported to a selection platform (step 5). Although, the steps 2 and 3 are not necessarily carried out at farms, these steps are preferably carried out at farms from the respect of efficiency.

Process from Selection Platform to Marine Transport

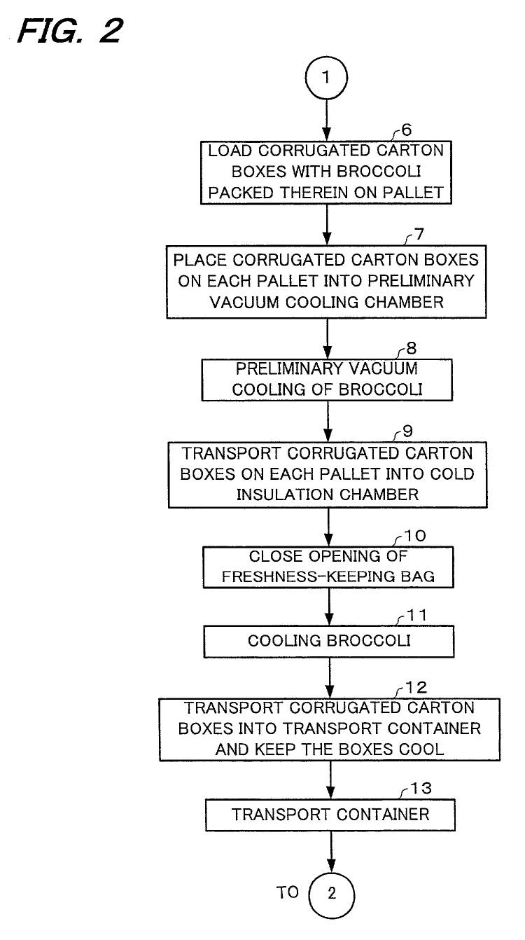

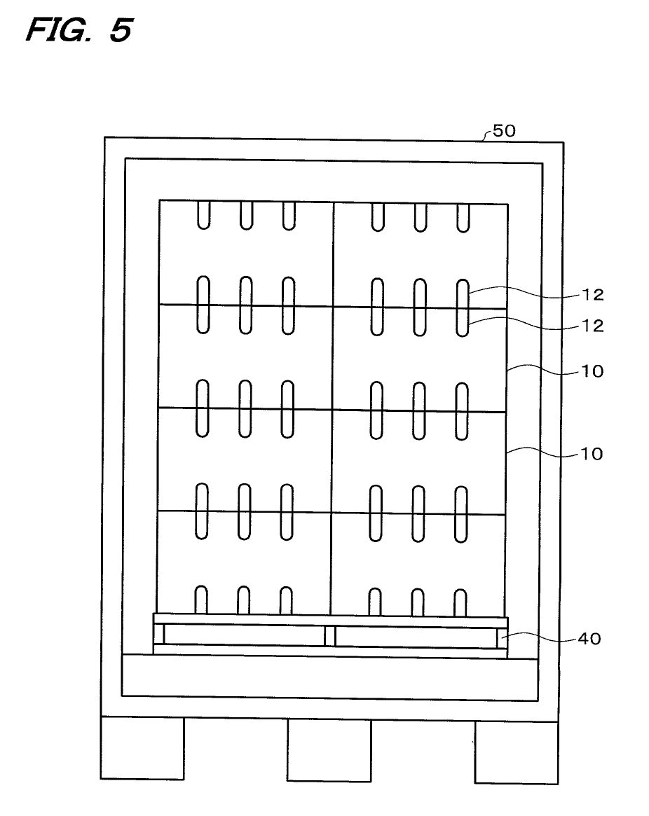

With reference to the flowchart in FIG. 2, the process subsequent to the process carried out at the selection platform is explained. First, a plurality of corrugated carton boxes 10 in which the broccoli 30 is packed therein are loaded on a pallet 40 shown in FIG. 5 (step 6), and the corrugated carton boxes are then brought into a preliminary vacuum cooling chamber 50 together with the pallet 40 (step 7). In the preliminary vacuum cooling chamber 50, then, the broccoli 30 is cooled in vacuum until the core temperature thereof reaches a temperature range of 2 to 6° C. In the present embodiment, the core temperature is cooled down to 4° C. The process requires a cooling time of about 40 minutes.

The reason of preliminary vacuum cooling within a temperature range of 2° C. to 6° C. resides in the shortening of the time required for cooling the broccoli 30 to a final storing temperature of about 0° C. Vacuum cooling of broccoli below 2° C. causes disadvantages due to the dehydration of the broccoli 30 as described below. When preliminary cooling of broccoli is terminated at a final temperature higher than 6° C., a very long time is required for cooling broccoli to the final cold insulation temperature at a subsequent cooling process (step 11). The temperature range for preliminary cooling is set in consideration of the above points.

Vacuum cooling herein means that preliminary vacuum cooling chamber 50 in which the broccoli 30 is brought is to be deaerated to vacuum so that the deprivation of vaporization heat cools the inside of the preliminary vacuum cooling chamber 50 when water inside the preliminary vacuum cooling chamber 50 is vaporized. The broccoli 30 in the preliminary vacuum cooling chamber 50 is cooled via the deprivation of the vaporization heat during the vaporization of water contained in the broccoli per se (step 8).

Because water is preliminarily deposited on the broccoli 30 by spraying at the step 3, the vaporization heat of the water during evaporation is also useful for cooling the broccoli 30. In other words, the vaporization of spray deposited water serves to reduce the amount of the vaporization of water contained in the broccoli 30 per se until the broccoli 30 is cooled to the aforementioned temperature.

The water deposition on the broccoli 30 prior to preliminary vacuum cooling prevents the broccoli 30 from dehydrating or prolongs the period until the broccoli 30 falls into a dehydrated state. In such manner, the broccoli 30 can be preserved at a satisfactory state or can be preserved for a longer time.

During preliminary vacuum cooling, additionally, the opening of the freshness-keeping bag 20 is preferably kept open. Steam emerged by the vaporization can smoothly be discharged outside the bag 20, to promote vaporization.

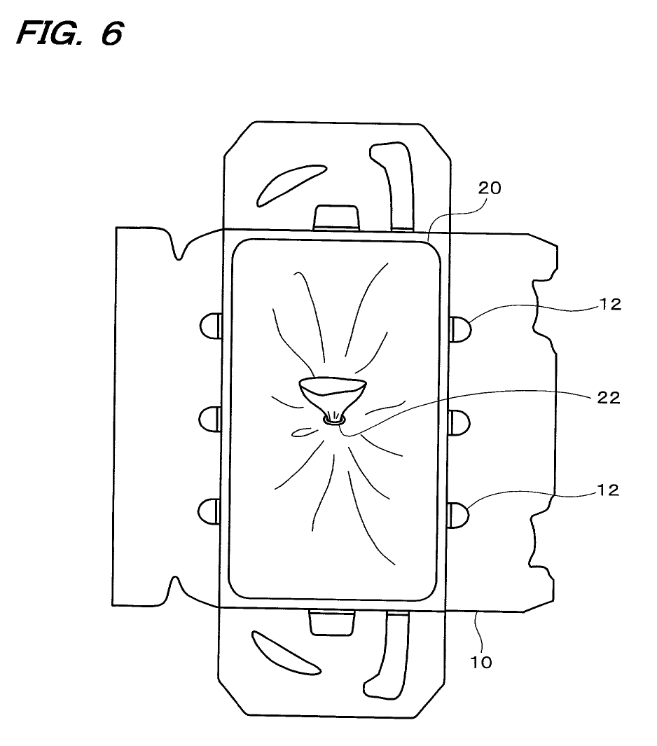

After the step of preliminary vacuum cooling, the corrugated carton box 10 in which the broccoli 30 is packed is brought in a cold insulation container (step 9). In the cold insulation container, for example, the opening of the freshness-keeping bag 20 is then closed with for example rubber band 22 and the like, as shown in FIG. 6 (step 10).

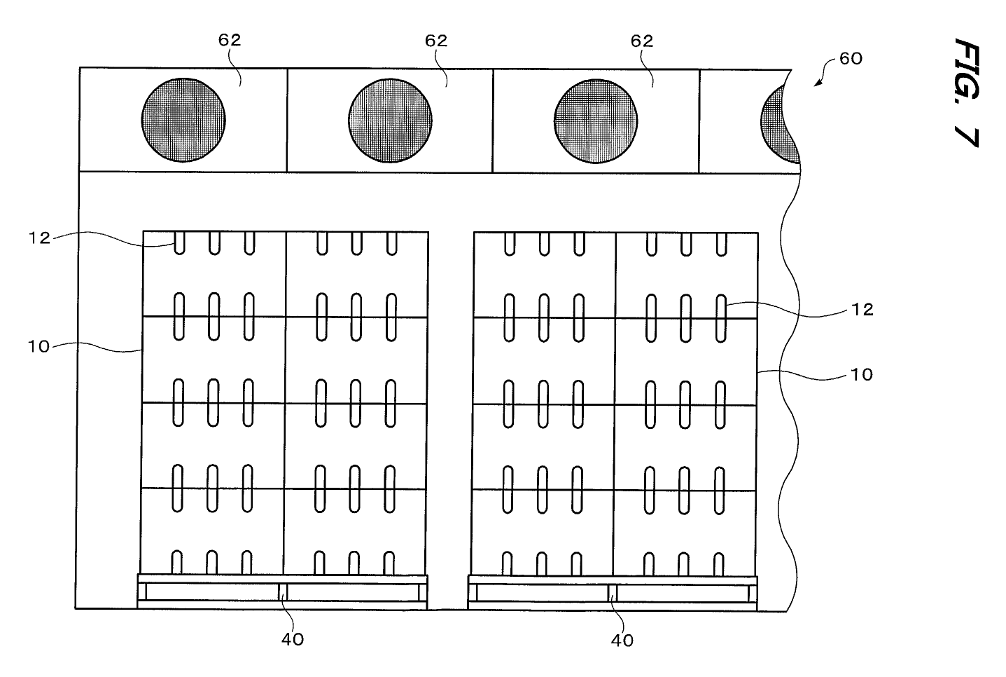

FIG. 7 shows the step of further cooling the broccoli 30 in each of the individual corrugated carton boxes 10 loaded on the pallet 40 in the cold insulation container 60 (step 11). The cold insulation container 60 has a space to arrange a large number of pallets 40, into which cooling air is blown from cooler 62 in an enforced manner.

The broccoli 30 in each corrugated carton box 10 is cooled to a core temperature of −1° C. to 3° C. by the enforced cooling air. For example, the period required for cooling the core temperature from 4° C. to 0° C. was about 15 hours. When the core temperature of the broccoli 30 is under −1° C., the flower bud portion (crown portion) and sliced section of the broccoli 30 change its color into black, due to so-called freezing phenomenon, which deteriorates the merchandise value. When the core temperature of the broccoli 30 is above 3° C., alternatively, the flower bud portion (crown portion) opens as time passed and changes its color into yellow, leading to fragile vegetable touch.

When the core temperature of broccoli at about 20° C. with no preliminary vacuum cooling is cooled down to 0° C. in cold insulation chamber 60 alone, the time period required for such cooling is so prolonged, involving the color change of the broccoli 30.

Alternatively, when the core temperature of the broccoli 30 is cooled to 0° C. via preliminary vacuum cooling, the broccoli 30 is thinned even after preliminary spraying, leading to the deterioration of the freshness. Additionally, the sliced part of the broccoli 30 is oxidized in that case, leading to the phenomenon that the sliced part is modified into black. Furthermore, the flower bud portion (crown portion) of the broccoli 30 is colored pale green, with too fragile food touch, leading to the reduction of the merchandise value.

To cool the broccoli 30 effectively in the cold insulation chamber 60, corrugated carton boxes 10 of the same shape (and dimension) should absolutely be used. As shown in FIGS. 4 and 6, air permeable holes 12 are formed in all six faces of the rectangular-parallelepiped box.

The air permeable holes 12 formed in the individual faces of one corrugated carton box 10 are in communication with the air permeable holes of adjacently facing corrugated carton boxes 10 in all four sides and upper and lower faces thereof, when a plurality of corrugated carton boxes 10 are loaded as shown in FIG. 7.

As described above, the spaces in all the corrugated carton boxes 10 are in communication through air permeable holes 12 to each other, as shown in FIG. 7. Accordingly, fresh cooling air can be circulated around the broccoli 30 placed in the spaces.

The individual steps of step 1 to step 11 as described above are preferably completed within 24 hours from the cropping time of the broccoli 30.

The corrugated carton box 30 in which the broccoli 30 is packed is transferred in a marine transport container (step 12). The temperature in the container is preset at −1° C. to +1° C., for example −1° C.; then, the broccoli is landed in Japan after the marine transport for about 10 days, for example (Step 13).

Process after Unloading

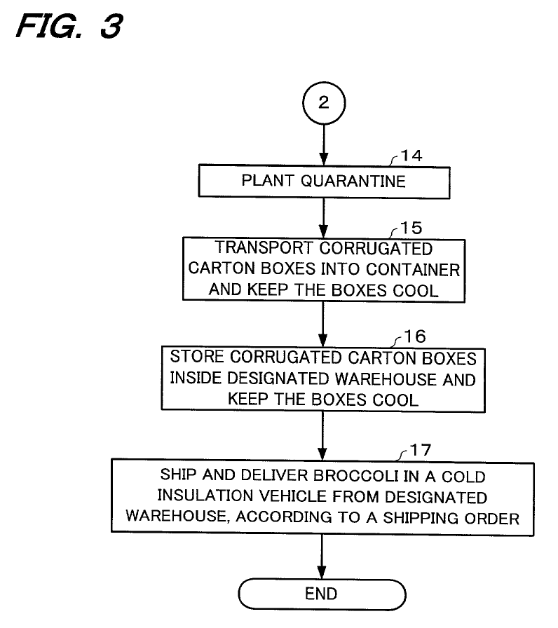

The steps after landing in Japan are described with reference to FIG. 3. First, the broccoli 30 landed is subjected to plant quarantine at the Japanese customs (step 14); then, corrugated carton box 10 is loaded in a domestic container retained at a temperature of −1 to +1° C., for example −1° C. (step 15), to be transported to a designated warehouse (step 16). The inside of the designated warehouse is also retained at a temperature of −1 to +1° C., for example −1° C.

According to the shipping order from customer, the broccoli 30 is shipped from the designated warehouse (step 17). Then, the corrugated carton box 10, in which the broccoli 30 is packed, is loaded in the cold insulation vehicle and is delivered to a central market or the center of a mass dealer such as supermarket over midnight and early morning. The cold insulation chamber of the cold insulation vehicle is also retained at a temperature of −1 to +1° C., for example −1° C.

With no execution of the cooling step after unloading as described above, the flower bud portion (crown portion) of the broccoli 30 changes its color into yellowish color, leading to the loss of the merchandise value.

Herein, the freshness of the broccoli 30 in the present embodiment is secured by adjusting the ratio of gases in the atmosphere in which the broccoli 30 is placed, using the freshness-keeping bag 20, in addition to or in cooperation with the cooling or the cold insulation effect described above.

The freshness-keeping bag 20 used in this embodiment is prepared, so as to allow the gas permeability and gas barrier property of the film composing the bag to preserve the freshness of the broccoli 30. More specifically, the oxygen volume per unit volume in the freshness-keeping bag 20 is reduced, compared with the oxygen volume in atmosphere; the oxygen volume is for example reduced to 15% to 16% per unit volume of the inside of the freshness-keeping bag 20, compared with the oxygen ratio in atmosphere, which is generally 21%. On contrast, the carbon dioxide volume per unit volume in the freshness-keeping bag 20 is raised above the carbon dioxide volume in atmosphere; the carbon dioxide ratio is elevated to for example 6% to 7%, in the freshness-keeping bag 20, compared with the carbon dioxide ratio in atmosphere, which is generally 0.6% to 0.9%.

As has been described above, the method of preserving the broccoli 30 from farms to delivery to consumers should be specifically described in a manual. Thus, such manual can bring about the following effects.

1. Conventionally used wax-coated corrugated carton box as a source of garbage to be classified or styrene foam as a dioxin source is never used. Therefore, a method of preserving fresh foods with an environmental safe performance can be provided.

2. Because the cost of ice and the cost of ice packing can be saved and the dimension and weight of the packing box therefor can be reduced, the transport cost can be reduced.

3. Because the dimension and weight of the packing box therefor can be reduced, persons who lack physical strength can handle such box.

4. The freshness, color and food touch of both the flower bud portion and stem portion of broccoli can be stably retained over a storage period.

Second Embodiment

In the second embodiment, all the processes including the processes in FIGS. 1 and 2 are carried out domestically, not in foreign countries. In this case, the plant quarantine at the step 14 in FIG. 2 is not required. The container for the steps 12 and 13 in FIG. 2 is also used as the container at the step 15 in FIG. 3. Accordingly, all the steps 12 to 15 are not necessarily carried out.

For the execution of the method domestically alone, the preliminary vacuum cooling temperature at the step 8, the cooling temperature at the step 11 and the temperature for cold insulation at the step 12 and thereafter can partially or wholly be modified appropriately in such a manner that these temperatures can be set at the same temperatures or higher than in the first embodiment.

The second embodiment brings about an additional effect in addition to the effects 1 to 4 described in the first embodiment. The additional effect is as follows: a longer storage time period of designated warehouse 60 at the step 16 can be certified because the time for transporting fresh products from domestic farms to domestic shipping addresses can be shortened very greatly. Thus, the time period from cropping to shipping can be set free at a degree such that the time period can be controlled, depending on the length of the storage time period in the designated warehouse 60, which maybe long or short. Such shipping control can contribute to the stabilization of broccoli prices.

The present invention is not limited to the embodiments described above but can be modified in various modifications within the scope of the invention. For example, the fresh foods to which the present invention is applied include other fresh products such as tomato and lettuce in addition to broccoli, and fresh fruits or processed products thereof. Then, the film material of the freshness-keeping bag 20 should be selected preferably to attain the gas ratio appropriate for the fresh products to be preserved inside.

What is claimed is:

1. A method of preserving fresh foods comprising:
a first step of depositing water on the fresh foods;
a second step of vacuum cooling the fresh foods in a vacuum cooling chamber; and
a third step of further cooling the vacuum cooled fresh foods by cooling air in a cooling chamber.

2. The method of preserving fresh foods according to claim 1,
wherein the first step comprises:
a step of packing the fresh foods in at least one transport box; and
a step of spraying water on the fresh foods packed in the transport box.

3. The method of preserving fresh foods according to claim 2,
wherein a freshness-keeping bag, in which the fresh foods are put is spread in the transport box, and
wherein the freshness-keeping bag is made of a material capable of reducing an oxygen volume per unit volume in the freshness-keeping bag, compared with the oxygen volume in atmosphere, and capable of raising a carbon dioxide volume per unit volume in the freshness-keeping bag, compared with the carbon dioxide volume in atmosphere.

4. A method of preserving fresh foods according to claim 3,
wherein the fresh foods are placed in plural layers in the transport box in which the freshness-keeping bag is spread, and
wherein in the first step, water is sprayed on the fresh foods in an upper top layer every time a layer of the fresh foods is packed in the box.

5. A method of preserving fresh foods according to claim 2, comprising a step of closing an opening of the freshness-keeping bag after the second step.

6. A method of preserving fresh foods according to claim 2,
wherein at least one air permeable hole is formed through each of six faces of the transport box which is a rectangular parallelepiped so that the cooling air used in the third step is circulated through the air permeable hole.

7. A method of preserving fresh foods according to claim 6,
wherein a plurality of transport boxes are placed in the cooling chamber in the third step and inner spaces of two of the transport boxes adjacently positioned are in communication each other through the air permeable hole of each of the transport boxes.

8. A method of preserving fresh foods according to claim 1,
wherein in the third step, the fresh foods are cooled to a temperature of −1 to 3° C.

9. A method of preserving fresh foods according to claim 8,
wherein in the second step, the fresh foods are vacuum cooled to a temperature of 2 to 6° C.

10. A method of preserving fresh foods according to claim 8,
wherein the fresh foods are fresh vegetables or fresh fruits, and
wherein the method comprises a step of harvesting the fresh vegetables or the fresh fruits at a temperature of 20° C. or less prior to the first step.

11. A method of preserving fresh foods according to claim 1, further comprising a step of placing the transport box, in which the fresh foods cooled in the third step, in a cold insulation container and then transporting the cold insulation container.

12. A method of preserving fresh foods according to claim 11, further comprising:
a step of storing the fresh foods in the cold insulation container in a warehouse kept cool; and
a step of delivering the fresh foods in a cold insulation vehicle.
